(19) United States
(12) Patent Application Publication
(10) Pub. No.: US 2017/0176207 A1
(43) Pub. Date: Jun. 22, 2017

(54) IN VEHICLE SYSTEM AND METHOD FOR PROVIDING INFORMATION REGARDING POINTS OF INTEREST

(71) Applicant: JAGUAR LAND ROVER LIMITED, Warwickshire (GB)

(72) Inventors: Matt Jones, Portland, OR (US); Richard Rowe, Portland, OR (US); Dale Crane, Hillsbro, OR (US); Jon Sims, Beaverton, OR (US)

(21) Appl. No.: 14/972,816

(22) Filed: Dec. 17, 2015

(51) Int. Cl. G01C 21/36; G06F 3/00; G06F 3/01; B60K 35/00; G01S 19/42

(52) U.S. Cl. CPC G01C 21/3605; G01C 21/3664; B60K 35/00; G01S 19/42; G06F 3/017; G06F 3/005; B60K 2350/1052; B60K 2350/1008

(57) ABSTRACT

An illustrative example vehicle navigation system includes a user interface having at least a display screen for providing a display output to a user and a controller, which includes at least one processor and memory associated with the processor. A first user input indicates a direction of user attention exterior to the vehicle. A second user input is different than the first user input. The controller determines that the first user input and the second user input indicate a desire for information regarding an object or location in the direction of user attention. The controller identifies at least one object or location in a vicinity of the vehicle based at least on the first user input. The user interface provides information regarding the identified object or location.

### TECHNICAL FIELD

The present disclosure relates to providing information to an individual in a vehicle regarding an object or location of interest to the individual. Aspects of the invention relate to a system, a vehicle and a method.

### BACKGROUND

With advances in computing technology, it has become increasingly possible to incorporate information and entertainment devices on vehicles. Navigation systems are one example that rely upon computing technology for providing automated route guidance to a driver. Such systems have proven useful and have gained widespread acceptance.

A primary feature of known navigation systems is the ability to automatically determine a route to a selected destination and provide route guidance to a driver. Many drivers feel an increased level of confidence when travelling in unfamiliar territory when they travel based on navigation system guidance. Additionally, the task of driving becomes more enjoyable because the driver will be less likely to miss a required turn, get off course, or even get lost because the navigation system provides prompts along the route. One side benefit is that a driver may be able to observe more of the surroundings while traveling along the route provided by the navigation system.

While such systems are effective at providing route guidance it would be useful to provide additional information to a driver or other individuals in a vehicle while they are traveling in the vehicle. One situation that current navigation systems do not readily address is when a driver or another individual in the vehicle notices a place or object, such as a historic landmark or a building while travelling. It would be beneficial to be able to provide additional information through a vehicle navigation system in a way that meets an individual's desires or needs in a more convenient and effective manner.

### SUMMARY OF THE INVENTION

Aspects and embodiments of the invention provide a system, a method and a vehicle as claimed in the appended claims.

According to an aspect of this invention there is provided a method including detecting a first user input from a user inside a vehicle, the first user input indicating a direction of user attention exterior to the vehicle, detecting a second user input from the user, the second user input being different from the first user input, determining that the first and second user input indicate a desire for information regarding an object or location in the direction of user attention, identifying at least one object or location in a vicinity of the vehicle based on at least the first user input, and providing information regarding the identified at least one object or location to the user.

In an embodiment having one or more features of the method of the previous paragraph, the first user input comprises at least one of a gesture or a gaze in the direction of user attention.

In an embodiment having one or more features of the method of any of the previous paragraphs, the gesture comprises pointing in the direction of user attention.

In an embodiment having one or more features of the method of any of the previous paragraphs, the second user input comprises at least one of a voice command from the user and user manipulation of a user interface input device.

In an embodiment having one or more features of the method of any of the previous paragraphs, the method includes determining the direction of user attention based on the first user input, determining a position of the vehicle at a time corresponding to at least one of the first user input and the second user input, determining a search scope based on the determined position of the vehicle and the direction of user attention and identifying the at least one object or location by determining whether any known objects or locations are within the search scope.

In an embodiment having one or more features of the method of any of the previous paragraphs, the search scope corresponds to a generally conical region having an apex near the determined position of the vehicle, the generally conical region having an axis that corresponds to the direction of user attention.

In an embodiment having one or more features of the method of any of the previous paragraphs, identifying the at least one object or location comprises determining the position of the vehicle relative to a map of a region that includes the position of the vehicle, the map including map data regarding known objects or locations within the region and determining if any known objects or locations are included as part of the map data on a portion of the map that corresponds to the search scope.

In an embodiment having one or more features of the method of any of the previous paragraphs, providing the information to the user comprises providing the user indications of any objects or locations within the search scope, the user being able to select at least one of the indications and providing the user information based on data regarding any selected one of the indications.

In an embodiment having one or more features of the method of any of the previous paragraphs, the method includes providing the user with directions to travel to the object or location corresponding to a selected one of the indications.

In an embodiment having one or more features of the method of any of the previous paragraphs, the method includes using global positioning satellite navigation system information and predetermined map data for the identifying and providing directions to the identified at least one object or location to the user.

According to another aspect of this invention there is provided a vehicle comprising at least one detector for detecting the first user input and a navigation system controller configured to perform one or more features of the method of the previous paragraphs.

According to another aspect of this invention there is provided a vehicle navigation system that includes first user input means for obtaining a first user input from a user inside a vehicle, the first user input indicating a direction of user attention exterior to the vehicle, second user input means for obtaining a second user input from the user, the second user input being different from the first user input, means for determining that the first and second user input indicate a desire for information regarding an object or location in the direction of user attention and for identifying at least one object or location in a vicinity of the vehicle based on at least the first user input and means for providing information regarding the identified at least one object or location to the user.

In an embodiment having one or more features of the system of the previous paragraph, the first user input means comprises at least one of a camera and a wireless transceiver, the second user input means comprises at least one of a user interface input mechanism and a microphone, the means for determining and identifying comprises at least one computing device comprising a processor and associated memory, and the means for providing information comprises a user interface including at least a display screen.

In an embodiment having one or more features of the system of any of the previous paragraphs, the first user input comprises at least one of a gesture or a gaze in the direction of user attention and the first user input means comprises at least one of a camera and a wireless transceiver.

In an embodiment having one or more features of the system of any of the previous paragraphs, the gesture comprises pointing in the direction of user attention.

In an embodiment having one or more features of the system of any of the previous paragraphs, the second user input comprises at least a voice command from the user and the second user input means comprises a microphone.

In an embodiment having one or more features of the system of any of the previous paragraphs, the second user input means comprises a user interface input device and the second user input comprises user manipulation of the user interface input device or user interaction with the user interface input device.

In an embodiment having one or more features of the system of any of the previous paragraphs, the means for determining and identifying is configured for determining the direction of user attention based on the first user input, determining a position of the vehicle at a time corresponding to at least one of the first user input and the second user input, determining a search scope based on the determined position of the vehicle and the direction of user attention and identifying the at least one object or place by determining whether any known objects or places are within the search scope.

In an embodiment having one or more features of the system of any of the previous paragraphs, the search scope corresponds to a generally conical region having an apex near the determined position of the vehicle, the generally conical region having an axis that corresponds to the direction of user attention.

In an embodiment having one or more features of the system of any of the previous paragraphs, the means for determining and identifying identifies the at least one object or location by determining the position of the vehicle relative to a map of a region that includes the position of the vehicle, the map including data regarding known objects or locations within the region; and determining if any known objects or locations are included as part of the data regarding a portion of the map that corresponds to the search scope.

In an embodiment having one or more features of the system of any of the previous paragraphs, the means for providing information to the user is configured for providing the user indications of any objects or locations within the search scope, the user being able to select at least one of the indications and providing the user information based on the map data regarding any selected one of the indications.

In an embodiment having one or more features of the system of any of the previous paragraphs, the means for determining and identifying controls the means for providing to provide the user with directions to travel to the object or location corresponding to a selected one of the indications.

In an embodiment having one or more features of the system of any of the previous paragraphs, the means for determining and identifying is configured for using global positioning satellite information and predetermined map data for the identifying and providing directions to the identified at least one object or location to the user.

According to another aspect of this invention there is provided a vehicle comprising the navigation system of any of the previous paragraphs.

According to another aspect of this invention there is provided a vehicle navigation system that includes a user interface having at least a display screen for providing a display output to a user and a controller, which includes at least one processor and memory associated with the processor. A first user input indicates a direction of user attention exterior to the vehicle. A second user input is different than the first user input. The controller determines that the first user input and the second user input indicate a desire for information regarding an object or location in the direction of user attention. The controller identifies at least one object or location in a vicinity of the vehicle based at least on the first user input. The user interface provides information regarding the identified object or location.

Within the scope of this document it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 diagrammatically illustrates an example embodiment of a system designed according to an embodiment of this invention associated with a vehicle;

FIG. 2 schematically illustrates selected portions of a system designed according to an embodiment of this invention;

FIG. 3 schematically illustrates selected portions of a system designed according to an embodiment of this invention and a portion of the interior of an associated vehicle; and

FIG. 4 is a flowchart diagram summarizing an example approach to providing information to a user.

### DETAILED DESCRIPTION

Embodiments of this invention provide information to an individual within a vehicle regarding a point of interest noticed by the individual.

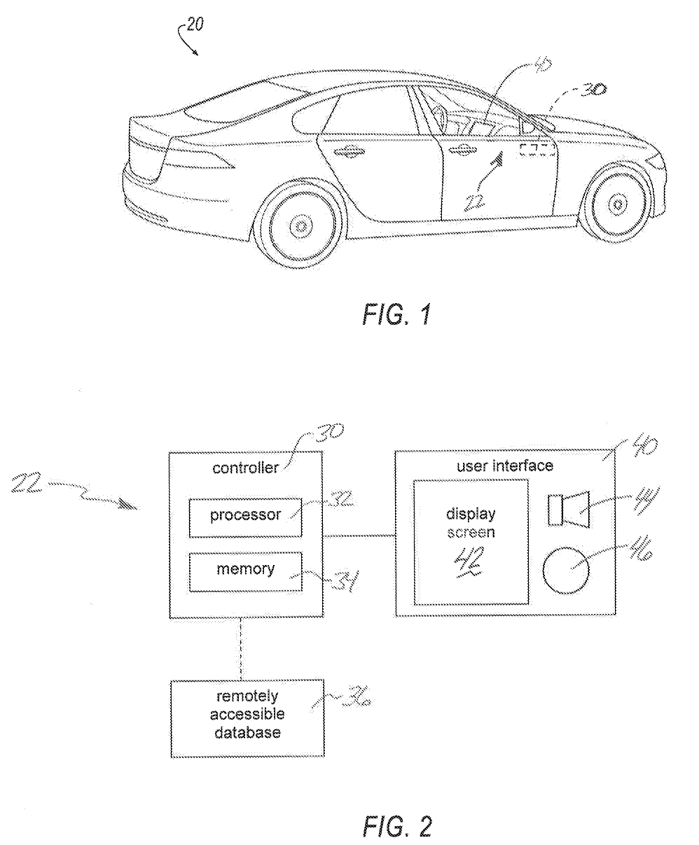

Referring to FIGS. 1 and 2, a vehicle 20 has an associated navigation system 22. A control means 30 includes at least one computing device 32, such as an electronic controller or a processor, and memory 34 associated with the computing device. The computing device 32 is a navigation system controller particularly configured to perform functions and automate determinations associated with a vehicle navigation system. The control means 30 is capable of processing navigation information using known techniques.

For discussion purposes, the control means 30 may be referred to as a controller in the following description.

The computing device 32 can comprise a control unit or computational device having one or more electronic processors (e.g., a microprocessor, a microcontroller, an application specific integrated circuit (ASIC), etc.), and may comprise a single device or multiple devices that collectively operate as the computing device 32. The term “controller,” “control unit,” or “computational device” may include a single controller, control unit, or computational device, and a plurality of controllers, control units, or computational devices collectively operating to provide the required control functionality.

A set of instructions is provided in the memory 34 in some embodiments which, when executed, cause the controller 30 to implement the control techniques mentioned in this description (including some or all of the functionality required for the described method). The set of instructions could be embedded in one or more electronic processors of the computing device 32; or alternatively, the set of instructions could be provided as software to be executed in the computing device 32. Given this description those skilled in the art will realize what type of hardware, software, firmware, or a combination of these will best suit their particular needs.

The memory 34 may include information useful for navigation determinations in addition to the instructions mentioned above. The memory 34 may be on board the vehicle 20, a remotely accessible data storage, or a combination of on board and remote memory.

Although the computing device 32 and the memory 34 are schematically shown separately in the drawing, that is primarily for discussion purposes. The computing device 32 and the memory 34 may be integrated into a single device or component. Additionally, they may be a portion of a controller that is used for other purposes, such as a vehicle engine control unit.

The controller 30 has access to a remotely accessible database 36 as schematically shown in FIG. 2. The system 22 uses known wireless communication techniques to access the database 36. In one example, the database 36 is available over the Internet. In some examples, the database 36 is available through a subscription service. In some examples, the controller 30 has access to multiple databases 36 with at least one of them being available over the Internet and at least one other being available through a subscription service.

The database 36 includes information that is useful to allow the controller 30 to identify points of interest to an individual in a vicinity of the vehicle. Information within the database 36 may include, for example, identities of various businesses or enterprises along with information regarding the location and hours of operation. Other types of information within the database 36 may include identity and location information regarding landmarks or historical sites. The database 36 may also include information regarding natural features, such as a body of water, a mountain, a park, etc. The controller 30 may use information from the database 36 to identify a point of interest to an individual within the vehicle 20 and provide information regarding that point of interest to that individual.

A user interface means 40 includes at least a display screen 42 that provides a visual output to an individual within the vehicle 20. An audio output or speaker 44 is provided in the illustrated example to provide audible indications regarding information of use or interest to an individual within the vehicle 20. The example user interface means 40 includes an input mechanism 46, such as a microphone, keypad, dial, switch, or pointer device, to facilitate the user providing input to the system 22.

One feature of the illustrated embodiment is an ability to provide information to an individual regarding a point of interest noticed by the individual while traveling in the vehicle 20. For example, a family may be traveling in the vehicle 20 through an area that is unfamiliar to them. One of the family members, for example, may notice an interesting building and wish to obtain information regarding that building. The system 22 is capable of providing information to any of the vehicle occupants in a convenient manner.

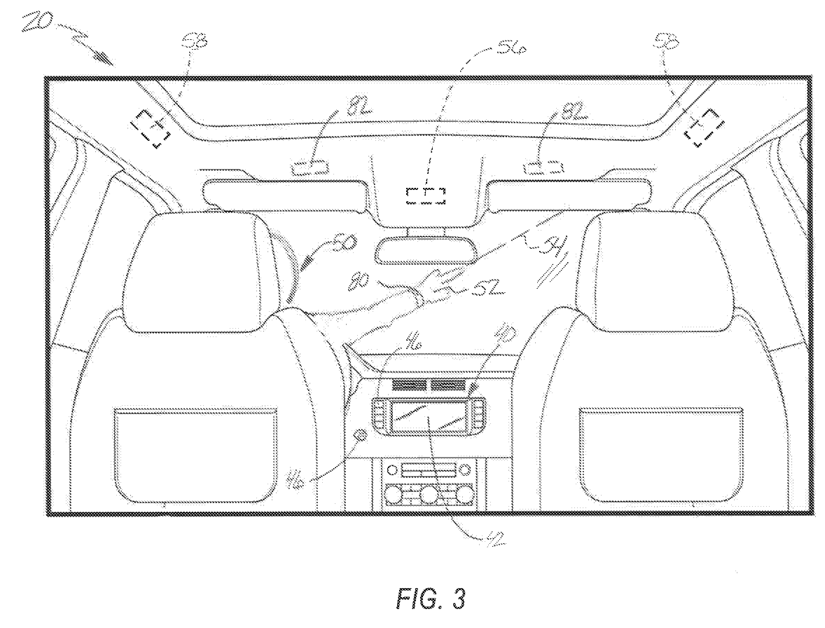

Referring to FIG. 3, which diagrammatically illustrates selected portions of an interior of the vehicle 20 and selected portions of the system 22, a user 50 is driving the vehicle 20. Assume for the sake of discussion that the user 50 notices an object or other point of interest exterior to the vehicle 20. According to the illustration, the point of interest would be to the right and forward of the vehicle 20. The user 50 gestures toward the point of interest by pointing at it or in a direction toward the point of interest. The system 22 is capable of interpreting such a user gesture as a first user input that indicates a direction of user attention. In FIG. 3, the direction of user attention is schematically shown at 54.

In the example of FIG. 3, a first user input means obtains the first user input from the user 50 inside the vehicle 20. In this example, the first user input means includes at least one camera 56 situated on or within the vehicle 20 to capture an image or video of the first user input, which in this example comprises a gesture such as pointing. In some example embodiments, the camera 56 is a stereoscopic camera that provides image or video information in a manner or format that allows for a three dimensional analysis so that the direction of user attention 54 may be determined by the controller 30. Some embodiments include using known spatial determination techniques based on video or image data for determining the direction of user interest.

In the example of FIG. 3, additional cameras 58 are provided and the controller 30 utilizes image or video information from a combination of at least two of the cameras 56, 58 for determining a position or orientation of that portion of the user utilized for making the gesture that constitutes the first user input. That information allows for the controller 30 to determine an approximation of the direction of user attention 54.

While pointing is one example user gesture that is useful as a first user input, other types of user input may be appropriate depending on the configuration of the system 22. For example, an individual's direction of gaze may be interpreted as a first user input indicating a direction of user attention. The cameras 56, 58 may be situated within the vehicle 20 to monitor the direction of the driver's or a passenger's gaze for detecting a first user input as the individual looks at a point of interest.

To ensure that the system 22 does not interpret all motion or eye movement by a user as if that were intended to be a first user input, the controller 30 in this example requires a second user input that is different than the first user input. The second user input may be, for example, manipulation of an input button or switch 46 associated with the display screen 42. Another example second user input is a voice command or statement that is detected by a microphone 46′. The user interface 40 includes a second user input means (e.g., a user interface input mechanism 46 or a microphone 46′) for obtaining such a second user input from the user 50.

The second user input may comprise a voice command such as “identify that,” “tell me what that is,” or “what is that?” The controller 30 may be pre-programmed to recognize such a command as a second user input to verify that a gesture or gaze of the user 50 was intended as a first user input. The second user input combined with the first user input is utilized to distinguish a gesture requiring information from other gestures. The system 22 preferably is configured not to overload users with information that is not desired.

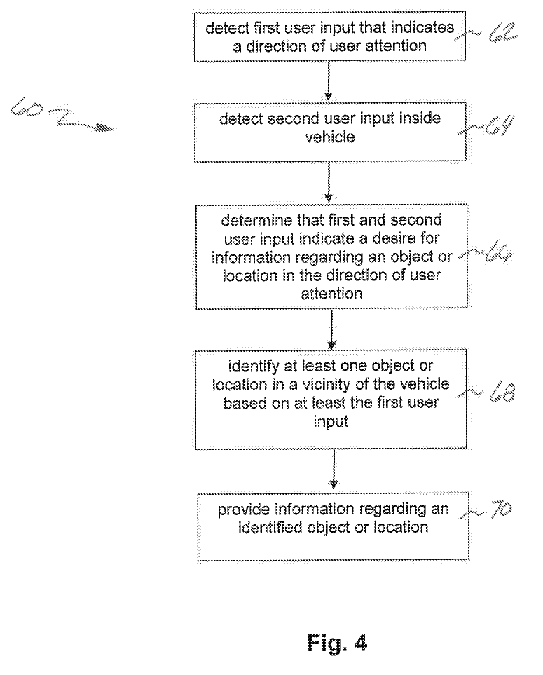

FIG. 4 includes a flowchart diagram 60 that summarizes an example approach to providing information to a user regarding a point of interest. At 62, the first user input is detected, for example, by one or more of the cameras 56, 58. The first user input indicates the direction of user attention, such as 54. At 64, the second user input inside the vehicle is detected by the second user input means associated with the user interface 40.

At 66, the controller 30 determines that the first and second user inputs indicate a desire for information regarding an object or location in the direction of user attention 54. The controller 30 identifies at least one object or location in a vicinity of the vehicle 20 at 68 based on at least the first user input. In an example embodiment, the controller 30 determines at least an approximate location of the vehicle 20 at the time of the first user input or the second user input. The controller 30 determines the direction of user attention 54 based on the first user input. In an instance where the first user input is the user's direction of gaze, the controller 30 uses known gaze direction determination techniques based on image or video information obtained by a camera 56, 58. If the first user input comprises a physical gesture, such as pointing, the controller 30 utilizes image or video data captured by at least one of the cameras 56, 58 to identify the direction of user attention 54. For example, the cameras 56, 58 may provide video information running on a thirty second override loop that can be analyzed by the controller 30 for purposes of identifying the direction of the gesture and the approximate orientation of that gesture within the vehicle 20 at the time of the second user input.

Once the controller 30 determines the direction of user attention 54 and the location of the vehicle 20, the controller 30 determines a search scope within which to attempt to identify an object or location at the time of the user input. The search scope originates at the vehicle location and follows a trajectory that corresponds to or approximates the direction of user attention. The search scope may be limited in length or distance from the vehicle location based upon an estimation of a likely field of view of the user 50.

Some example controllers 30 determine a search scope that corresponds to a generally conical region having an apex near the position of the vehicle and an axis that corresponds to the direction of user attention. Utilizing a generally conical search scope allows for identifying objects or locations with more accuracy in three dimensional space. For example, if the terrain in the direction of user attention includes a hillside, a three dimensional search scope allows the controller 30 to discern between potential points of interest at a lower elevation compared to a higher elevation, depending on the determined direction of user attention. Some example embodiments do not require or include a three dimensional search scope, but instead, utilize a two dimensional representation or estimation of a search scope that is centered on or otherwise corresponds to the determined direction of user attention.

When determining a three dimensional search scope, the controller 30 may take into account information regarding the angle of elevation of the user's gesture relative to the vehicle 20. The controller 30 may also use information regarding the vehicle orientation based upon a six-degree-of-freedom inertial measurement unit that operates in a known manner to provide vehicle orientation information. Other information that may be used by the controller in this context includes elevation information based on the vehicle location, which may be available from the navigation system GPS database, map data in the database 36, or on-board atmospheric pressure measurement obtained in a known manner.

The controller 30 utilizes information from the database 36 to identify any potential points of interest within the search scope. The controller 30 in this example identifies as many points of interest within the search scope as possible based on the information from the database 36.

Once at least one object or location in a vicinity of the vehicle 20 has been identified, the controller 30 causes the user interface 40 to provide information regarding any identified object or location to the user at 70. In one example, the information is presented first as an identification of any object or location identified by the controller 30. One example includes providing indications of such objects or locations in an order beginning with the one that is closest to the position of the vehicle. Another embodiment begins the presentation of identified objects or locations in an order that begins with the one that is closest to the direction of user attention. When such indications are provided, the user 50 may select one of them to obtain further information through the user interface 40. The selection may be made by manipulating a switch or button 46 or by speaking a command that is detected by the microphone 46′.

Additional information that may be provided to the user 50 in some embodiments includes further details regarding the identified object or location. Such information will vary depending on what the identified point of interest actually is. In some examples, additional information is provided to the user 50 including an option to select navigation directions from the current vehicle position to the location of the identified point of interest. The controller 30 will use known automated navigation system techniques to determine such a route and provide guidance to the user when that option is chosen by the user.

Some examples include providing information to the user by presenting a visual representation of a vicinity of the identified point of interest with an indication of the position of that point of interest on the visual representation. For example, a map of the area or vicinity surrounding the point of interest may be presented on the display screen 42 with additional information as may be requested by the user.

While a display screen 42 is represented in FIG. 3 as being a distinct display screen within the vehicle 20, some embodiments include a display provided on the windscreen of the vehicle 20. In some such embodiments, an indicator of the identified point of interest is presented on the windscreen in a location that corresponds to an approximate position where that point of interest would have been noticed by an individual looking through the windscreen at the time of providing the first and second user inputs.

The embodiment of FIG. 3 includes another feature for determining the first user input. In this example, the user 50 is wearing a wristband 80 that includes a transmitter that emits a wireless signal. Detectors 82 are situated on or within the vehicle 20 that utilize known short range wireless communication technologies or protocols for detecting the wireless signal from the transmitter 80. The detectors 82 in such an embodiment are at least part of the first user input means. In this example, the detectors 82 comprise transceivers or receivers that are compatible with at least one of ultra-wide band, Bluetooth, infrared, or ZigBee communications. In one example, the transmitter associated with the wristband 80 comprises an ultra-wide band transceiver, such as the single chip transceivers available from DecaWave.

The detectors 82 detect a signal from the transmitter of the wristband 80 and the controller 30 uses known triangulation techniques to determine the location of the transmitter within the interior of the vehicle 20. Such location information may be tracked over a few seconds to determine the user gesture provided as the first user input. Alternatively, the location of the transmitter at the time of the second user input may be utilized as at least some of the information processed by the controller 30 for determining the direction of user attention.

As can be appreciated from the preceding description, the system 22 is able to obtain and provide information to an individual within a vehicle regarding a point of interest noticed by that individual in a manner that allows the individual to interact with the system 22 in a very natural manner. Information regarding a variety of points of interest can be conveniently and easily obtained by the individual.

The information provided by the system 22 enhances an individual's experience along a journey and makes it easier for the individual to travel to a point of interest noticed along the way.

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

We claim:

1. A method, comprising:
detecting a first user input from a user inside a vehicle, the first user input indicating a direction of user attention exterior to the vehicle;
detecting a second user input from the user, the second user input being different from the first user input;
determining that the first and second user input indicate a desire for information regarding an object or location in the direction of user attention;
identifying at least one object or location in a vicinity of the vehicle based on at least the first user input; and
providing information regarding the identified at least one object or location to the user.

2. The method of claim 1, wherein the first user input comprises at least one of a gesture or a gaze in the direction of user attention.

3. The method of claim 2, wherein the gesture comprises pointing in the direction of user attention.

4. The method of claim 2, wherein the second user input comprises at least one of a voice command from the user and user manipulation of a user interface input device.

5. The method of claim 1, comprising
determining the direction of user attention based on the first user input;
determining a position of the vehicle at a time corresponding to at least one of the first user input and the second user input;
determining a search scope based on the determined position of the vehicle and the direction of user attention; and
identifying the at least one object or location by determining whether any known objects or locations are within the search scope.

6. The method of claim 5, wherein the search scope corresponds to a generally conical region having an apex near the determined position of the vehicle, the generally conical region having an axis that corresponds to the direction of user attention.

7. The method of claim 5, wherein identifying the at least one object or location comprises:
determining the position of the vehicle relative to a map of a region that includes the position of the vehicle, the map including data regarding known objects or locations within the region; and
determining if any known objects or locations are included as part of data regarding a portion of the map that corresponds to the search scope.

8. The method of claim 7, wherein providing the information to the user comprises:
providing the user indications of any objects or locations within the search scope, the user being able to select at least one of the indications; and
providing the user information based on data regarding any selected one of the indications.

9. The method of claim 8, comprising providing the user with directions to travel to the object or location corresponding to a selected one of the indications.

10. The method of claim 1, comprising
using global positioning satellite navigation system information and predetermined map data for the identifying; and
providing directions to the identified at least one object or location to the user.

11. A vehicle comprising at least one detector for detecting the first user input and a navigation system controller configured to perform the method of claim 1.

12. A vehicle navigation system, comprising:
first user input means for obtaining a first user input from a user inside a vehicle, the first user input indicating a direction of user attention exterior to the vehicle;
second user input means for obtaining a second user input from the user, the second user input being different from the first user input;
means for determining that the first and second user input indicate a desire for information regarding an object or location in the direction of user attention and for identifying at least one object or location in a vicinity of the vehicle based on at least the first user input; and
means for providing information regarding the identified at least one object or location to the user.

13. The system of claim 12, wherein
the first user input comprises at least one of a gesture or a gaze in the direction of user attention; and
the first user input means comprises at least of a one camera and a wireless transceiver.

14. The system of claim 13, wherein the gesture comprises pointing in the direction of user attention.

15. The system of claim 13, wherein the second user input comprises at least a voice command from the user and the second user input means comprises a microphone.

16. The system of claim 13, wherein the second user input means comprises a user interface input device and the second user input comprises user manipulation of the user interface input device or user interaction with the user interface input device.

17. The system of claim 12, wherein the means for determining and identifying is configured for
determining the direction of user attention based on the first user input;
determining a position of the vehicle at a time corresponding to at least one of the first user input and the second user input;
determining a search scope based on the determined position of the vehicle and the direction of user attention; and
identifying the at least one object or location by determining whether any known objects or locations are within the search scope.

18. The system of claim 17, wherein the search scope corresponds to a generally conical region having an apex near the determined position of the vehicle, the generally conical region having an axis that corresponds to the direction of user attention.

19. The system of claim 17, wherein the means for determining and identifying identifies the at least one object or location by:
determining the position of the vehicle relative to a map of a region that includes the position of the vehicle, the map including data regarding known objects or locations within the region; and
determining if any known objects or locations are included as part of data regarding a portion of the map that corresponds to the search scope.

20. The system of claim 19, wherein the means for providing information to the user is configured for
providing the user indications of any objects or locations within the search scope, the user being able to select at least one of the indications; and
providing the user information based on data regarding any selected one of the indications.

21. The system of claim 20, wherein the means for determining and identifying controls the means for providing to provide the user with directions to travel to the object or location corresponding to a selected one of the indications.

22. The system of claim 12, wherein the means for determining and identifying is configured for
using global positioning satellite information and predetermined map data for the identifying; and
providing directions to the identified at least one object or location to the user.

23. A vehicle comprising the navigation system of claim 12.
